(19) United States
(12) Patent Application Publication
(10) Pub. No.: US 2009/0037257 A1
(43) Pub. Date: Feb. 5, 2009

(54) SYSTEM FOR ELECTRONIC COMMERCE

(76) Inventors: Brian Stuckey, Minneapolis, MN (US); Jennifer Katz, Minneapolis, MN (US); Robert Rudelius, McLean, VA (US); Steven W. Lundberg, Edina, MN (US)

Correspondence Address: SCHWEGMAN, LUNDBERG & WOESSNER, P.A., P.O. BOX 2938, MINNEAPOLIS, MN, 55402, US

(21) Appl. No.: 12/184,892

(22) Filed: Aug. 1, 2008

Related U.S. Application Data
(60) Provisional application No. 60/953,913, filed on Aug. 3, 2007.

(51) Int. Cl. G06Q 30/00; G06Q 10/00

(52) U.S. Cl. 705/10; 705/14

(57) ABSTRACT

A system that utilizes peer influences to help advertisers to reach target audiences. This system used peer recommendations through Widgets and comments to influence consumer behavior. This is a system for placing advertising on Influencer websites or pages includes determining the audience of the Influencer and setting tags to characterize the audience. An advertiser chooses tags to characterize an advertising campaign or offer and the system determines which of the influences provide matches or partial matches to the advertising campaigns or offers. Influencers pick which campaigns they wish to offer to their audience and install a Widget on their website or page(s) that is used to display ads and process click-throughs. Influencers are rewarded with payments or reward incentives for placing the campaigns or offers and/or if the campaigns are successful. A web system is configured to provide the necessary functions to support the ad placement and rewards process.

### TECHNICAL FIELD

This application relates generally to computer networks and more particular to a system for electronic commerce.

### BACKGROUND

Electronic commerce has grown rapidly in recent years and now is fundamental to the world economy. The ability to effectively target consumers in this medium is therefore increasingly important to businesses.

### BRIEF DESCRIPTION OF THE DRAWINGS

FIG. 1 illustrates an example functional block diagram of an online system for placement and monitoring of online advertising.

FIGS. 2-5 illustrate example flow charts for setting up accounts, creating campaigns and selecting offers from those campaigns among advertisers and Influencers.

FIGS. 6A, 6B, 7 and 8 illustrate example methods for creating tags and matching tags between Influencers and advertisers.

FIG. 9 illustrates an example method for creating an Influencer Quotient for an Influencer.

FIGS. 10 through 22 illustrate various example processes and functions used by Influencers, and end viewers.

FIG. 23 illustrates an example of different configurations of Widgets available to an Influencer.

FIG. 24 illustrates commenting and feedback on offers by Influencers.

FIG. 25 a method of aggregating comments from FIG. 25 and analyzing the breakdown of the user feedback as well as reporting the data to Advertisers in various forms.

FIG. 26 illustrates an automated method of setting up offers without human intervention.

FIG. 27 illustrates a user's ability to select between better offers or a larger quantity of offers, based on their preferences.

FIG. 28 illustrates a system according to an example embodiment of the present invention.

FIG. 29 illustrates a block diagram of a machine in the example form of a computer system within which a set of instructions, for causing the machine to perform any one or more of the methodologies discussed herein, may be executed.

### DETAILED DESCRIPTION

In the following detailed description of exemplary embodiments of the invention, reference is made to the accompanying drawings which form a part hereof, and in which is shown, by way of illustration, specific exemplary embodiments in which the invention may be practiced. These embodiments are described in sufficient detail to enable those skilled in the art to practice the invention, and it is to be understood that other embodiments may be utilized and that logical, mechanical, electrical, and other changes may be made without departing from the scope of the present invention.

According to one example embodiment, the system described herein supports online marketing programs designed to leverage the power of peer-recommendations to promote actions desired by advertisers. The system provides that influential bloggers, website operators, and social networker users (collectively called Influencers) can review, select and recommend pre-screened, valuable offers from advertisers for their friends and viewers (Viewers). Using Widget and tagging technologies, the system allows advertisers to direct their offers to the Influencers where Viewers are in the target market. Influencers with the largest communities or communities that generate the best “take rates” may, in one example embodiment, receive a higher “The Influencer Quotient (IQ)” than Influencers with smaller communities and lower “take rates”. The IQ is a value that may represent the combination of community size and community responsiveness. The Influencers with the highest IQ scores may, in one example embodiment, receive the right to view and select from advertisers' most valuable offers. In another example embodiment, Influencers use their IQ to select offers whose sum IQ value is equal to or less than that of the Influencer's IQ.

The system, thus, can create a virtuous-circle. Influencers who are able to offer their communities the most valuable advertiser-offers will likely see their online reputations or status enhanced and their Viewer communities grow. Influencer's IQ score will increase and as a result, they will receive the right to view and select even more valuable offers for their Viewers.

Thus, using the system described herein, advertisers can follow the trail of blogs and social networking sites to find and recruit customers all over the world through peer endorsements.

Unlike traditional keyword advertising, the Influencers may, in some embodiments, have say over which ads and offers are shown to their Viewers and which are not. The preexisting loyalty between the Influencer and his or her Viewers may make the message more powerful for the consumer and more effective for the advertiser.

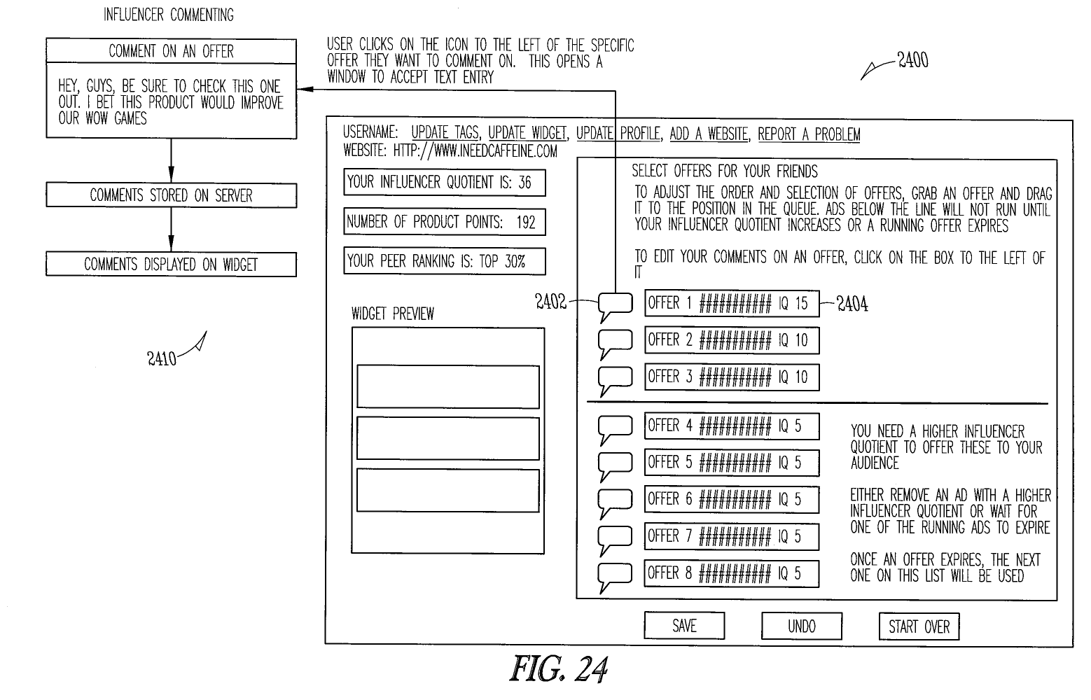

Unlike traditional advertising, Influencers may, in some embodiments, be allowed to add comments (e.g., FIG. 24) and their own text to offers they provide to their end viewer audience. These comments may be displayed to end viewers and they may be aggregated and analyzed for advertisers.

As used herein, the term “Influencer” is an individual who publishes messages with a personal viewpoint or opinion, wherein the message are published on a web page, website or other Internet-accessible medium, and wherein the individual has a following or audience that is influenced by the messages. The messages may include text or pictorial or other forms of communication. The Influencer may be identified by his or her real name or a pseudonym. An Influencer may be, for example a person who publishes messages on a website, including a blogger, social network participant or other website owner. The Influencer may draw many viewers to their web pages or website and influence a large number of viewers, or a small number of viewers. A “Widget” is an external component of a website which displays to viewers. “Tags” are a brief text description of a concept, generally an adjective or a noun, alternatively referred to as keywords. A “Tag Cloud” is a collection of tags that represent a larger concept—such as an Influencer or an Advertiser offer. An “Offer” is a component of a campaign, generally taking the form of a discount, promotion or ad. A “Campaign” is either a single offer or a collection of related offers.

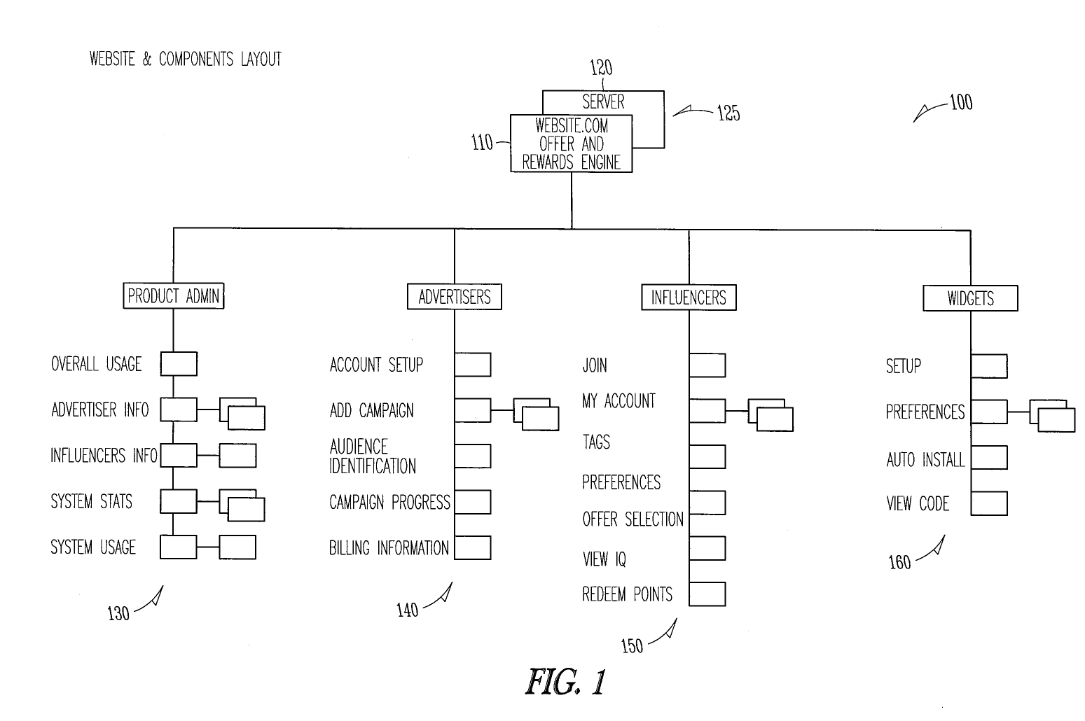

Referring now to FIG. 1, there is illustrated a functional block diagram of a first example embodiment of an online advertisement system according to the inventive subject matter described herein. An offer and rewards engine 110 works in conjunction with a database server 120 to provide a website 125 to support an online ad placement service. A plurality of advertising administration functions 130, advertiser functions 140, Influencer functions 150 and Widget functions 160 are provided.

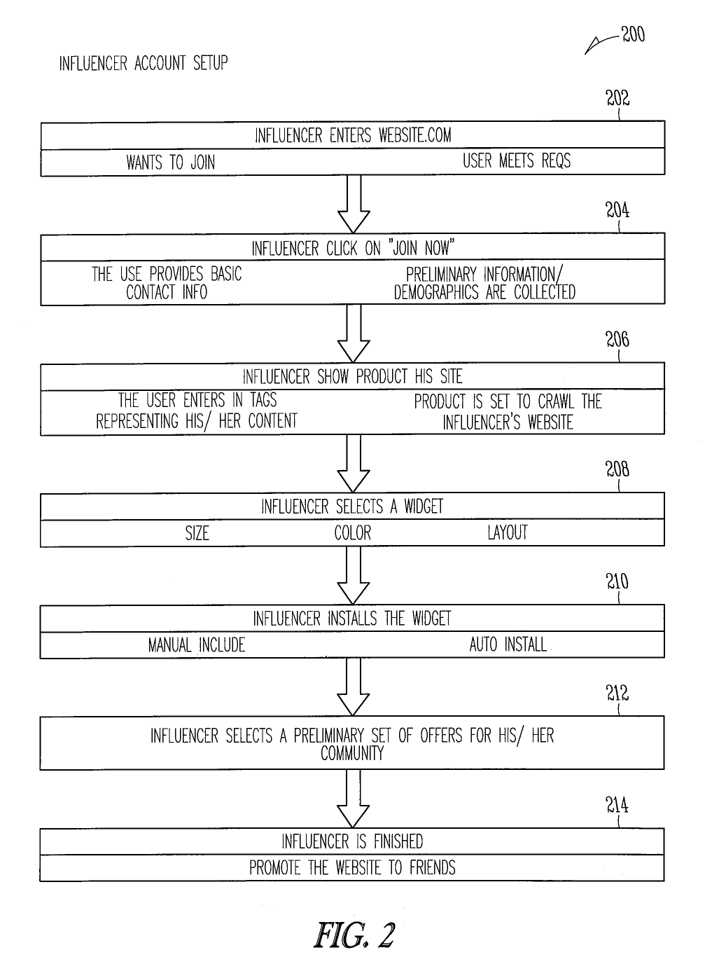

FIG. 2 illustrates an example flow chart 200 for setting up an Influencer account using the Influencer functions 150. As illustrated, the Influencer may enter 202 the website 125 where the requirements for signing up may be checked. The user may join 204 the ad placement service in which case they enter basic contact and demographic information. The Influencer then may disclose 206 to the service his or her content as may, for example, be on the Influencer's website, web page(s) and/or blog. The website 125 may also be set to crawl the Influencer's website to determine key words and content of the Influencer's site. The Influencer may then select a Widget 208, for example, by color, size, content and layout. The Widget may be installed 210 on the Influencer's website or page(s), either manually or automatically. The Influencer may also select 212 a preliminary set of offers for his or her community to view, through the installed Widget. This finishes 214 the Influencer's sign up, Widget installation and ad selection process.

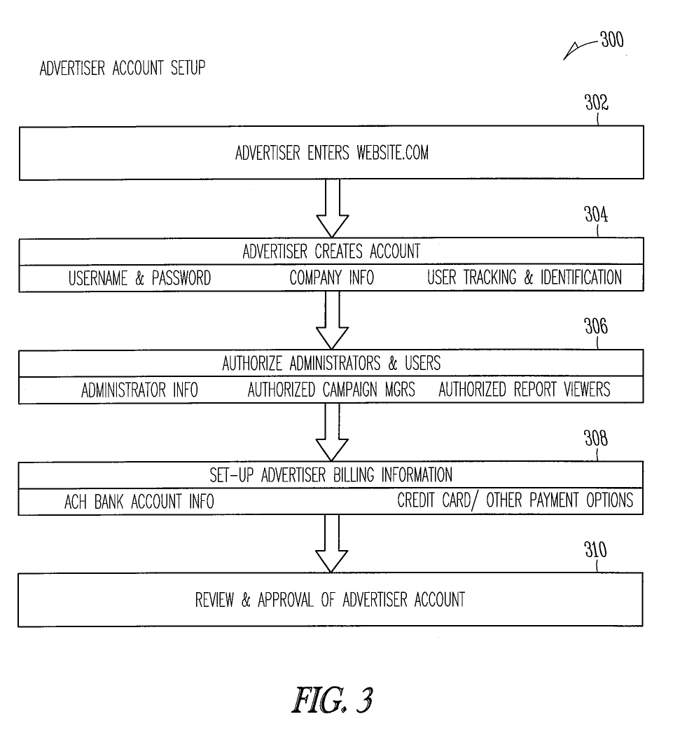

FIG. 3 illustrates an example flow chart 300 for advertisers to sign up for the ad placement service. The advertiser may enter 302 the site 125, create an account 304, authorize administrators and users 306, set up billing information 308, and reviews and approves 310 of the advertiser account.

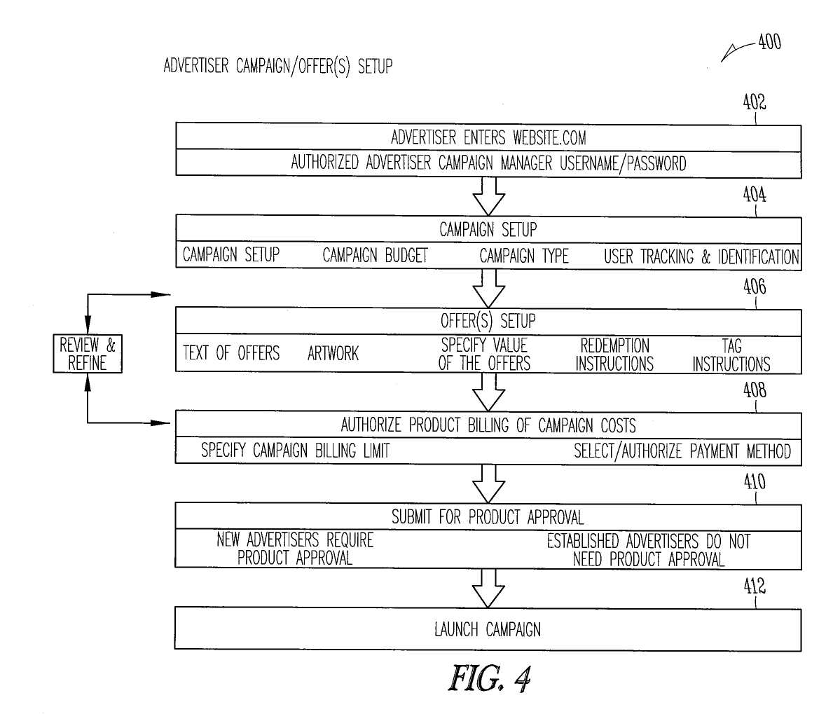

FIG. 4 illustrates an example flow chart 400 wherein an advertiser can set up a campaign/offer. An authorized advertiser representative enters 402 the website 125. A campaign may be set up 404, including setting a campaign budget, a campaign type and user tracking and identification. Offer set up 406 may include setting the text of offers, artwork, budget, value of the offers, redemption instructions and tag instructions. Campaign billing information may also be entered 408, wherein the campaign billing limit may be set and the payment method selected. New offers may be submitted 410 and may or may not require approval by website 125 personnel. New campaigns and offers may then be launched 412.

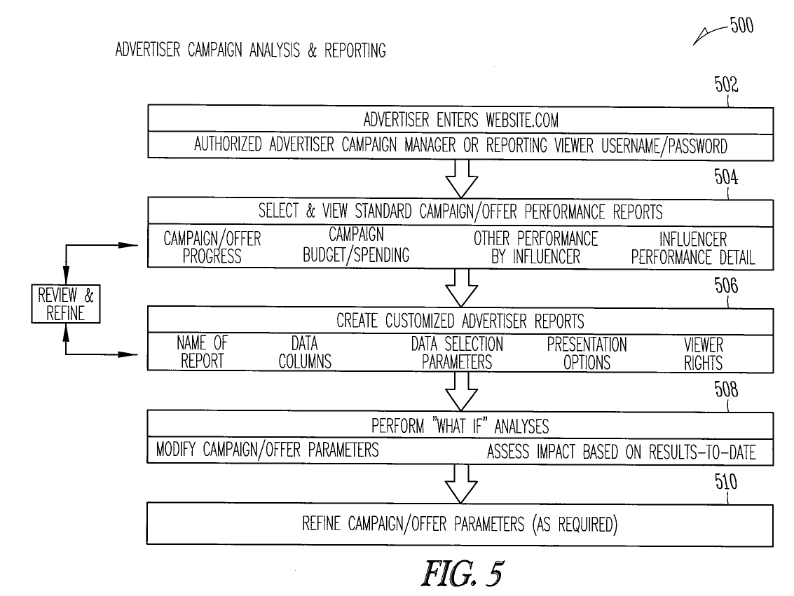

FIG. 5 illustrates an example flow chart 500 of an advertiser entering 502 an ad placement website 125 and reviewing campaign/offer performance 504 reports, including which campaigns/offers are in progress, the budget/spending for them, performance by individual Influencers, and details of any given Influencer. The advertiser may create 506 customized reports, perform “what if” analyses 508 and refine campaigns/offers 510 as required.

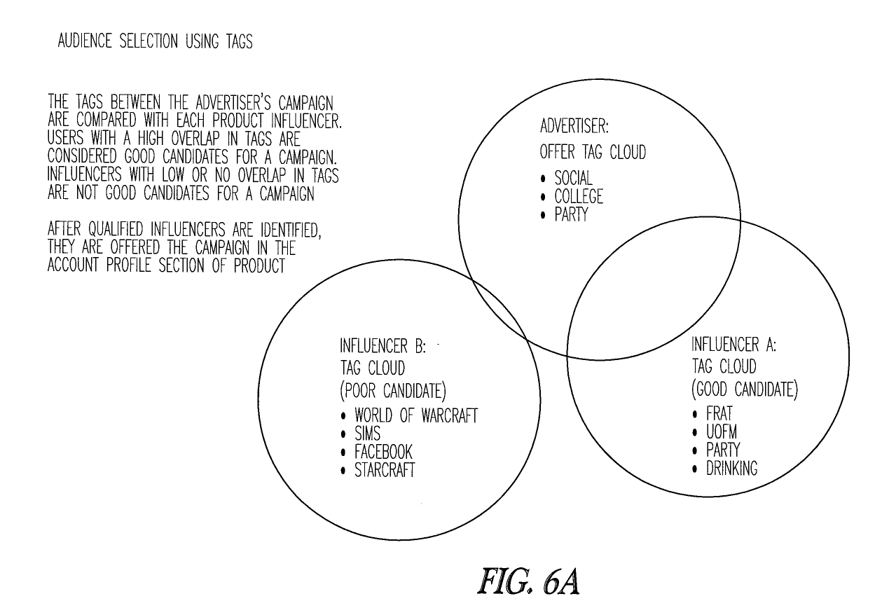

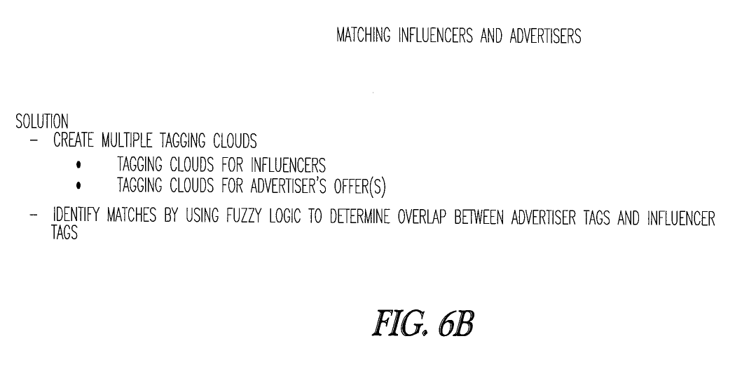

According to one example embodiment, as illustrated in FIG. 6A, the tags between the Advertiser's campaign may be compared by server 120 with each Advertising Influencer. Users with a high overlap in tags are considered good candidates for a campaign. Influencers with low or no overlap in tags are not good candidates for a campaign.

After a preliminary group of Influencers have been identified by tag matching, the system then may remove the influencers who do not have a sufficient IQ to show the offers to their communities.

After qualified Influencers are identified, they are offered the campaign in the account profile section of Advertising.

As illustrate in FIG. 6B, multiple offers may be created. This may be done by duplicating the offer tagging clouds and ad content. Matches may be identified between tagging clouds, for example using fuzzy logic to determine an overlap between advertiser tags and Influencer tags.

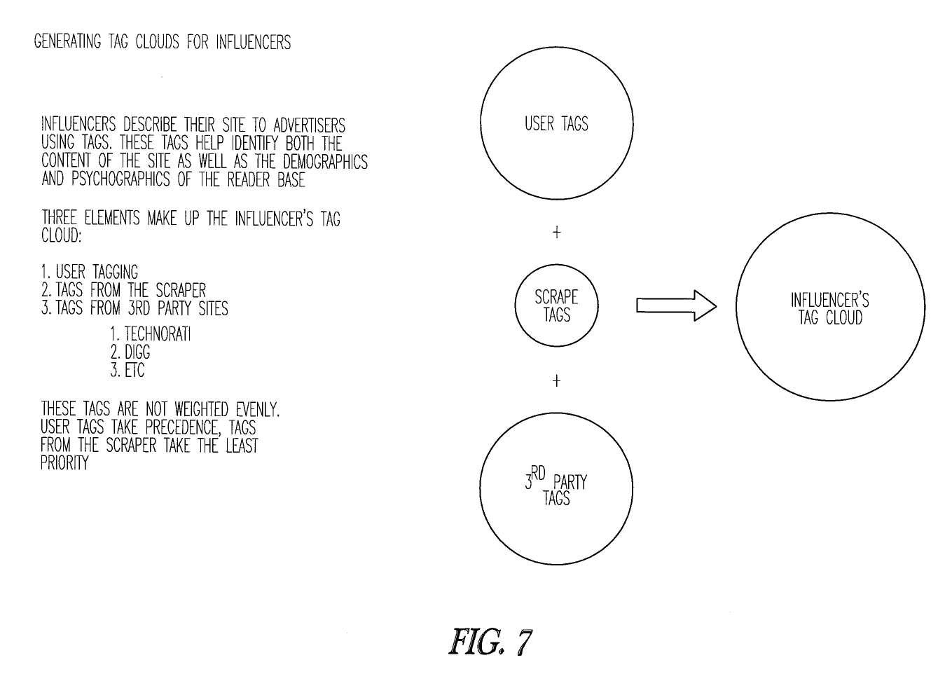

According to one example embodiment shown in FIG. 7, Influencers may describe their site to advertisers using tags. These tags help identify both the content of the site as well as the demographics and psychographics of the reader base. According to one example approach, three elements may make up the Influencer's Tag Cloud: Users self Tagging, Tags from the scraper, and tags from 3rd party sites (e.g., Technorati, Digg, etc.) These tags may not be weighted evenly. For example, user tags may take precedence and tags from the scraper may take the least priority.

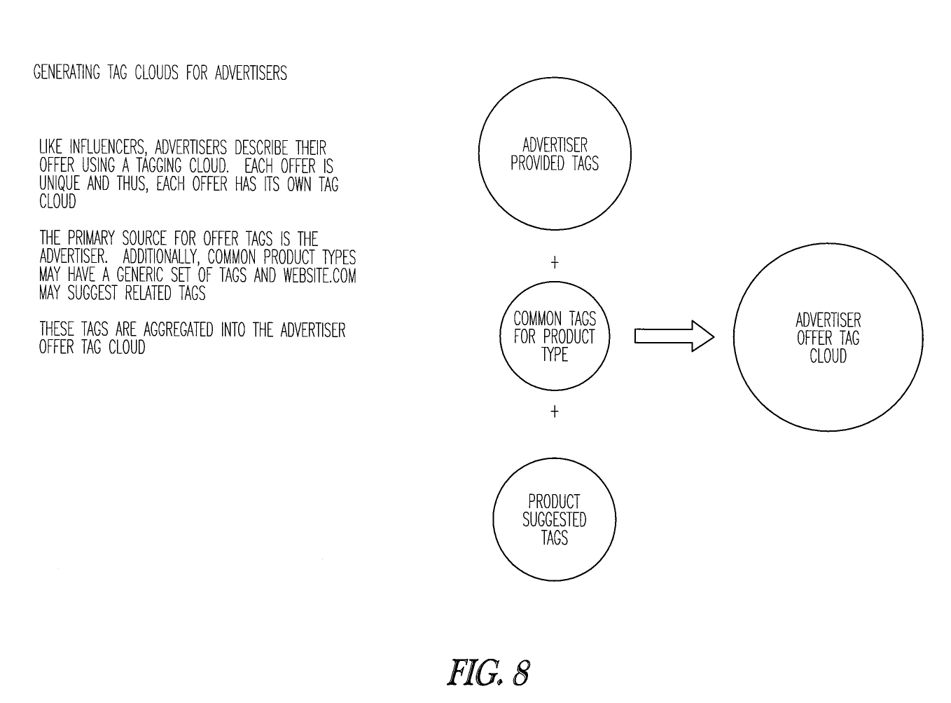

According to another example embodiment illustrated in FIG. 8, like Influencers, advertisers may describe their offer using a tagging cloud. Each offer is unique and thus, each offer has its own tag cloud. The primary source for offer tags is the Advertiser. Additionally, common product types may have a generic set of tags and Website.com may suggest related tags. These tags may be aggregated into the Advertiser Offer Tag Cloud.

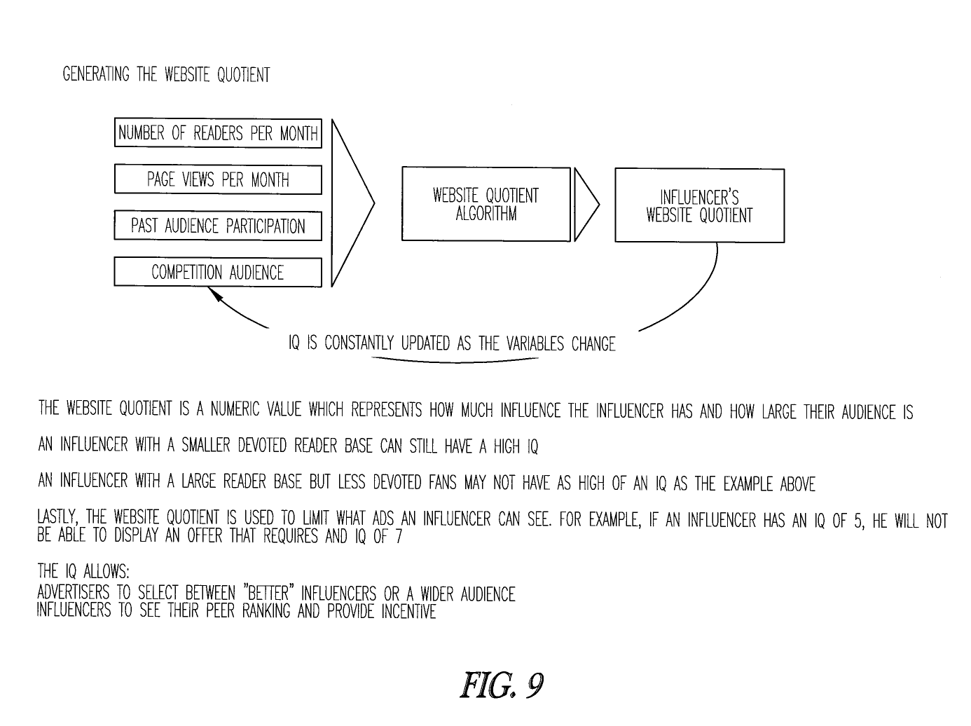

As illustrated in FIG. 9, The Influencer Quotient is a numeric value that represents how much influence the Influencer has and how large their audience is. An Influencer with a smaller, devoted reader base can still have a high IQ. An Influencer with a large reader base but less devoted fans may not have as high of an IQ as the example above.

Also, in this example embodiment, the Influencer Quotient is used to limit what ads an Influencer can see. For example, if an Influencer has an IQ of 5, he will not be able to display an offer that requires and IQ of 7. The IQ allows the advertisers to select between “better” Influencers or a wider audience. Influencers use the IQ to see their peer ranking and provide incentive to select offers their community uses to increase their IQ. The Influencer Quotient may be determined in any way desired.

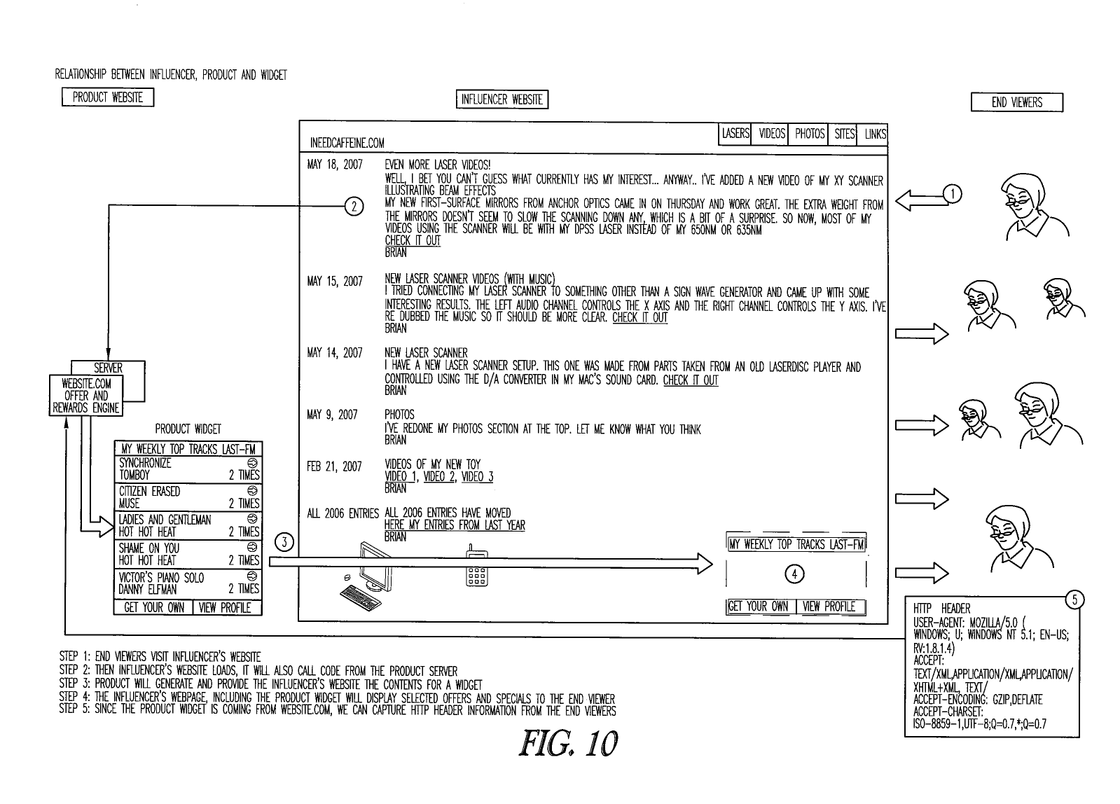

Referring now to FIG. 10, there is illustrated an example overall process flow wherein the various parties to an advertising transaction use the website 125 and the advertising service to place ads and earn ad placement fees and rewards. The following steps are illustrated in FIG. 10:

Step 1: End Viewers visit Influencer's website.

Step 2: Then Influencer's website loads, it will also call code from the Website server

Step 3: Website will generate and provide the Influencer's website the contents for a Widget

Step 4: The Influencer's webpage, including the Website Widget will display selected offers and specials to the end viewer

Step 5: Since the Website Widget is coming from Website.com, the inventive subject matter captures HTTP Header information, cookies, and other information from the End Viewers.

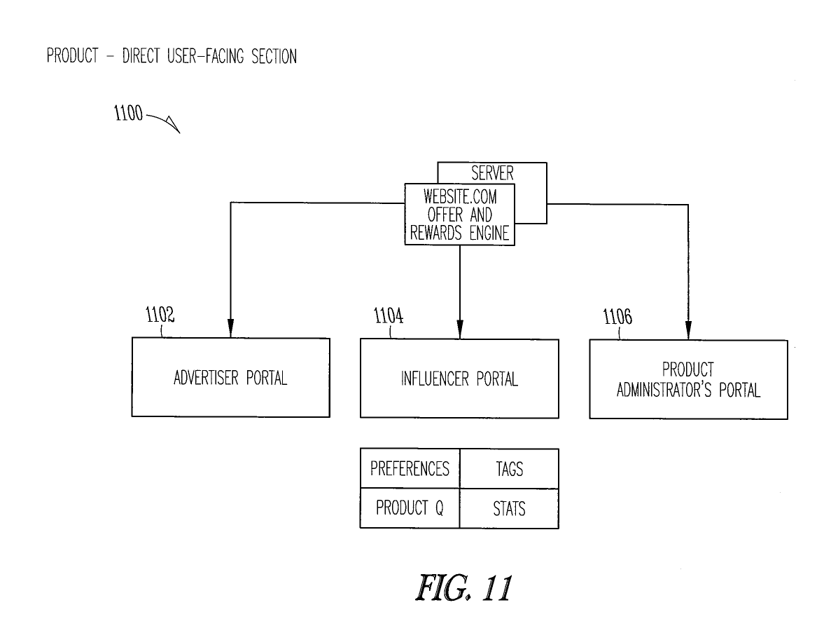

Referring now to diagram 1100 in FIG. 11, it is illustrated how the website 125 may provide an advertising portal 1102, an Influencer portal 1104 and a website administration portal 1106.

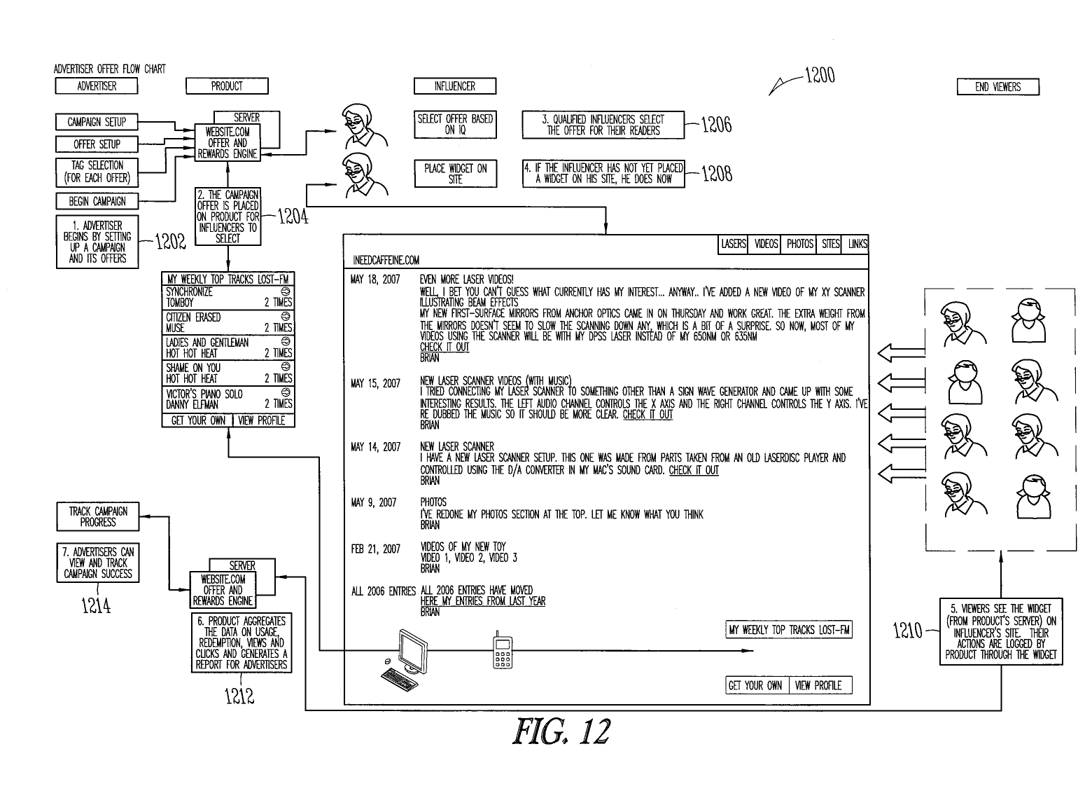

Referring now to the diagram 1200 of FIG. 12, there is illustrated an example process for using the system and method of the inventive subject matter wherein an advertiser begins 1202 by setting up a campaign and its offers. The campaign is placed on the website 125 for Influencers to select 1204. Qualified Influencers may select 1206 the campaign/offer for their website/web page(s). If the Influencer has not yet placed a Widget on their site, he/she may do so at this time 1208. Viewers then see 1210 the Widget (served by the website 125 server) on the Influencer's site/page(s). The actions of viewers viewing or interacting with the Widget may be logged by the website 125 using the Widget. The website 125 may aggregate the data on usage, redemptions, views and clicks and generate a report for advertisers 1212. Advertisers can view and track campaign success 1214.

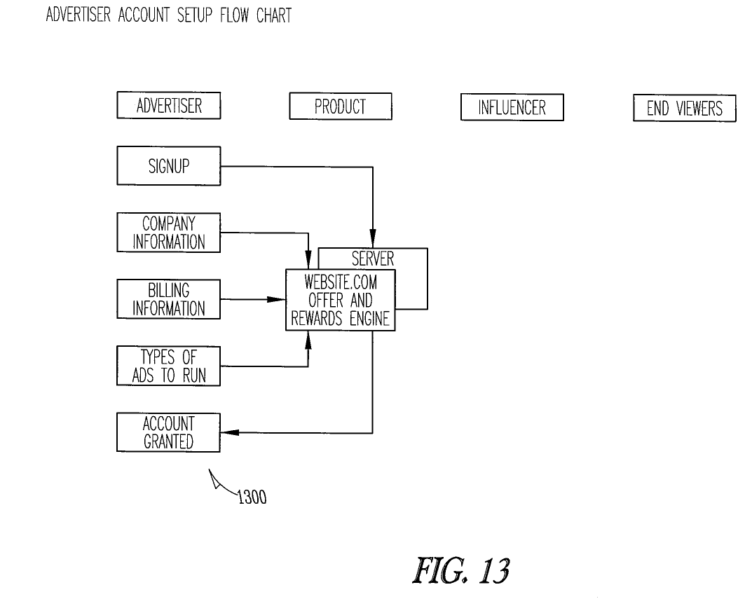

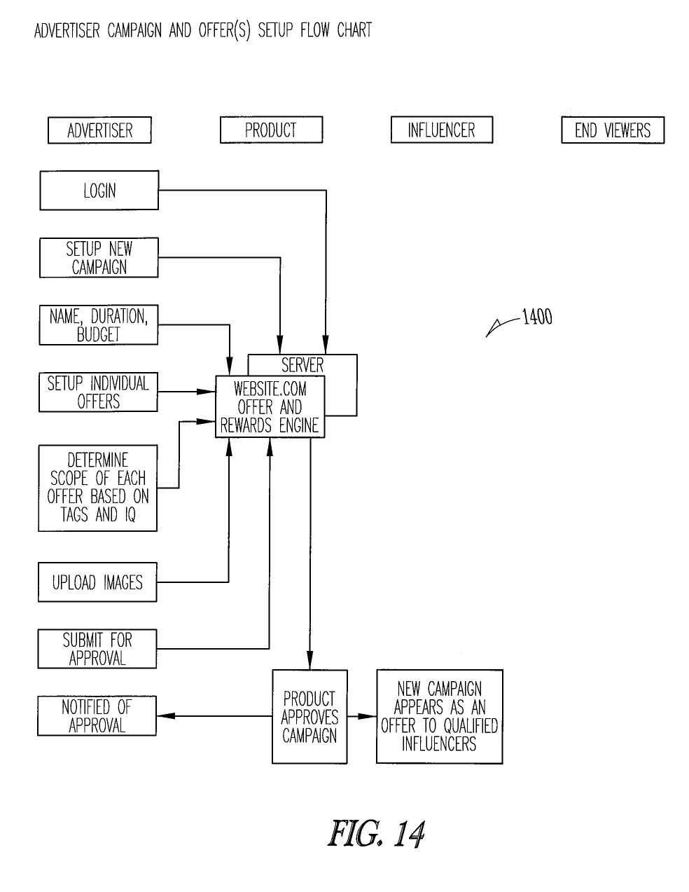

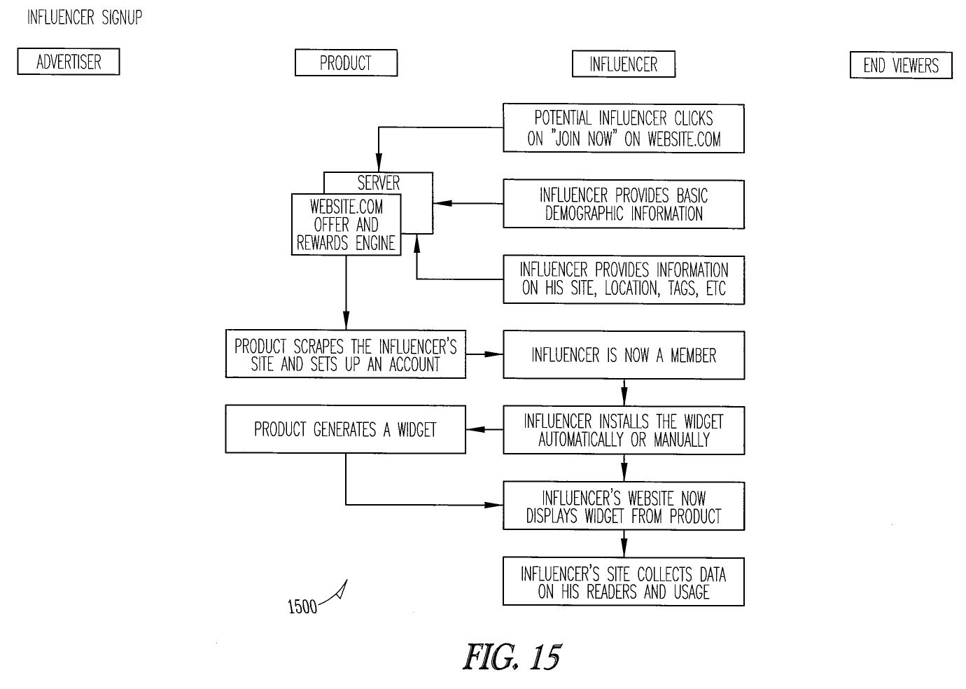

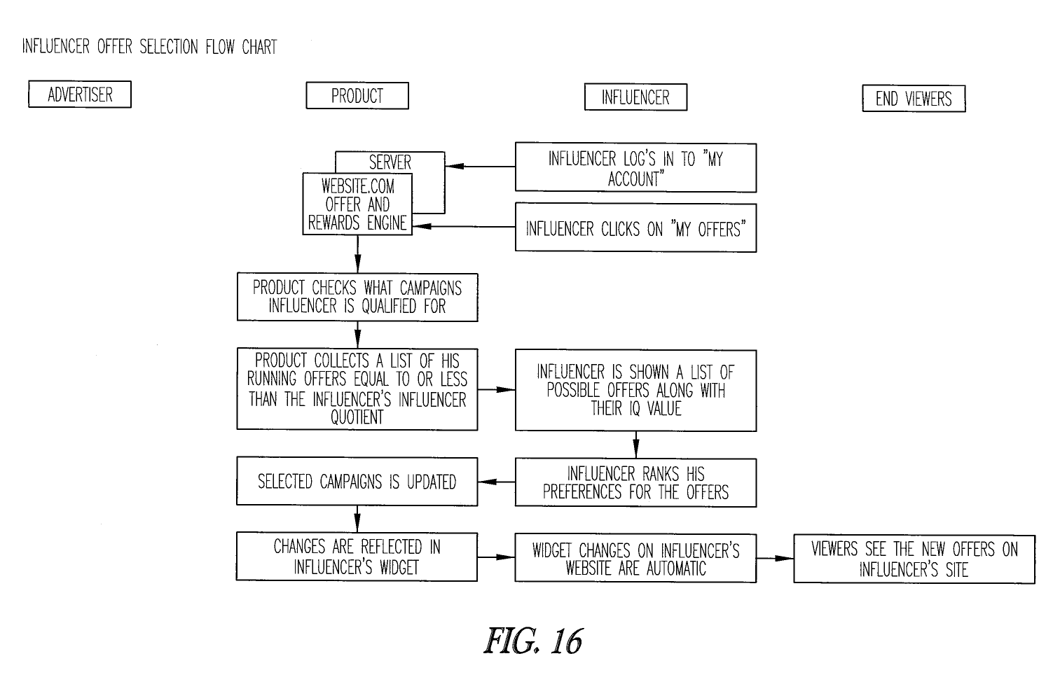

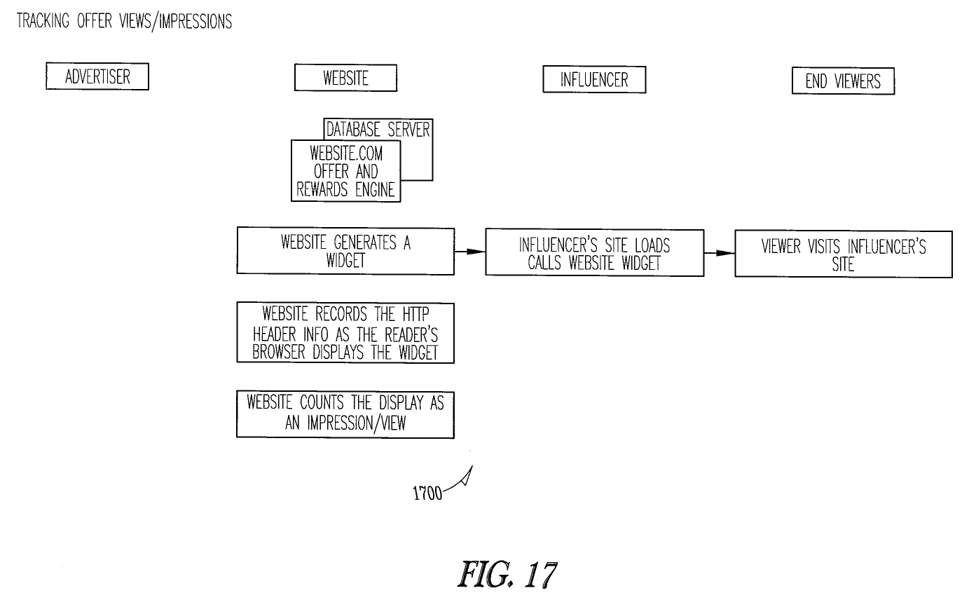

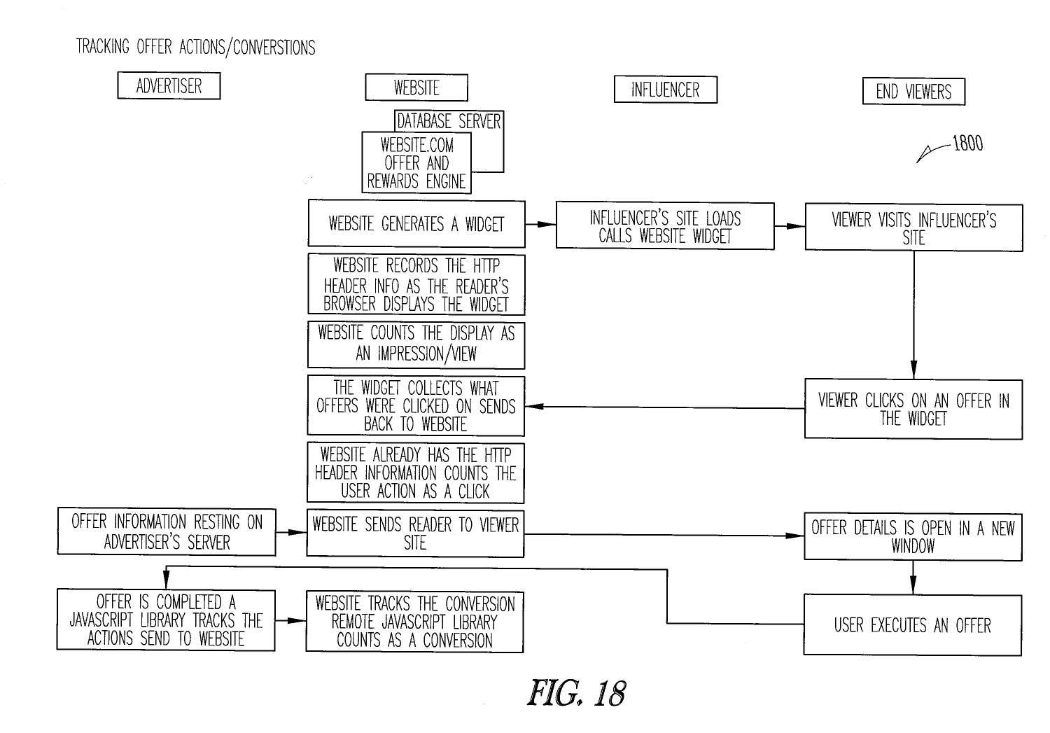

FIG. 13 to FIG. 20 illustrate various additional details of advertisers, Influencers and end users interacting with the website 125 to perform various tasks and functions and to take advantage of the service and system provided thereby. FIGS. 13 and 14 illustrate example functions and process 1300 and 1400, respectively, used by an advertiser to administer their account and set up and administer campaigns and offers that can be offered to Influencers. FIG. 1500 illustrates example functions and process 1500 used by an Influencer to establish an account and privileges to run offers. FIGS. 16 and 17 illustrate example functions and process 1600 and 1700, respectively, performed by an Influencer to select offers to present to his or her end viewers and to have those offers displayed by a widget on the Influencer's website. FIG. 18 illustrates example functions and processes 1800 used to present an offer to an end viewer using a widget and for the end viewer to select the offer and execute it if desired, for example by clicking on it and performing additional data entry steps.

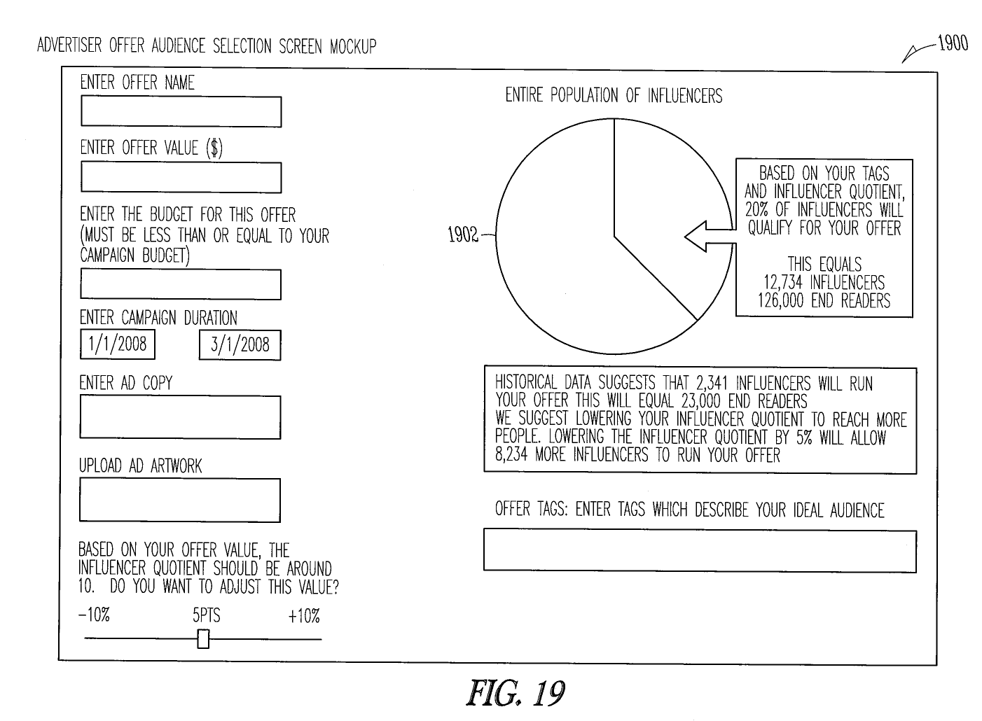

FIG. 19 illustrates an example screen display to be used by an advertiser to enter an offer, wherein the number of Influencers qualifying to run the offer is displayed 1902 based on the tags entered by the advertiser for the offer.

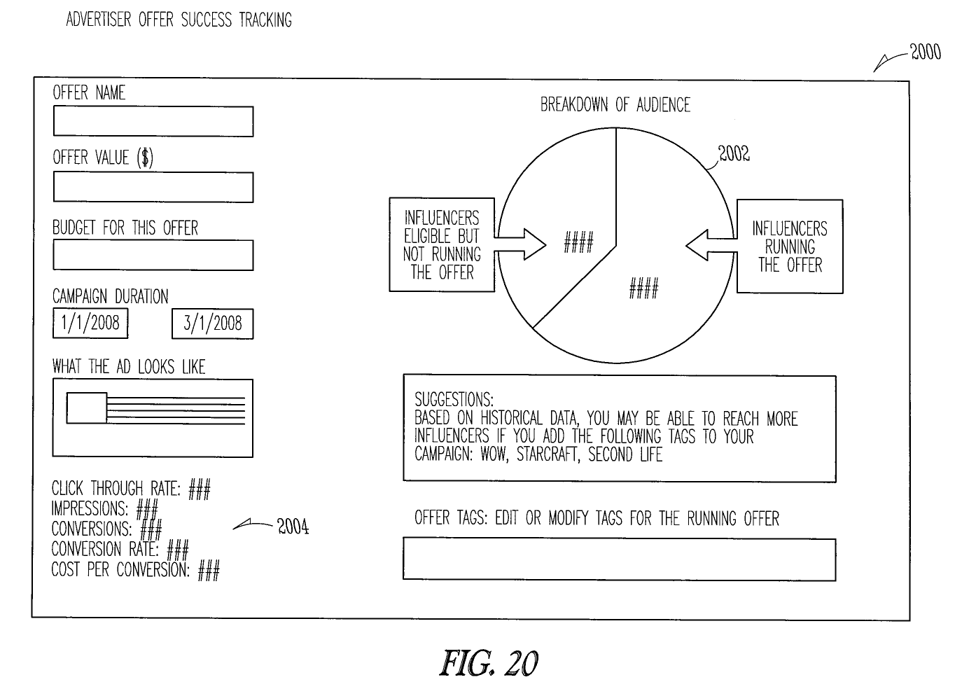

According to one example embodiment illustrated in FIG. 20, a screen display of website 125 may illustrate how an advertiser may view a report generated by the website to determine, for example, the percentage or number 2002 of Influencers running or not running a campaign or offer extended by the advertiser. Click through rates, impressions, conversions and cost per conversion 2004 may also be tracked.

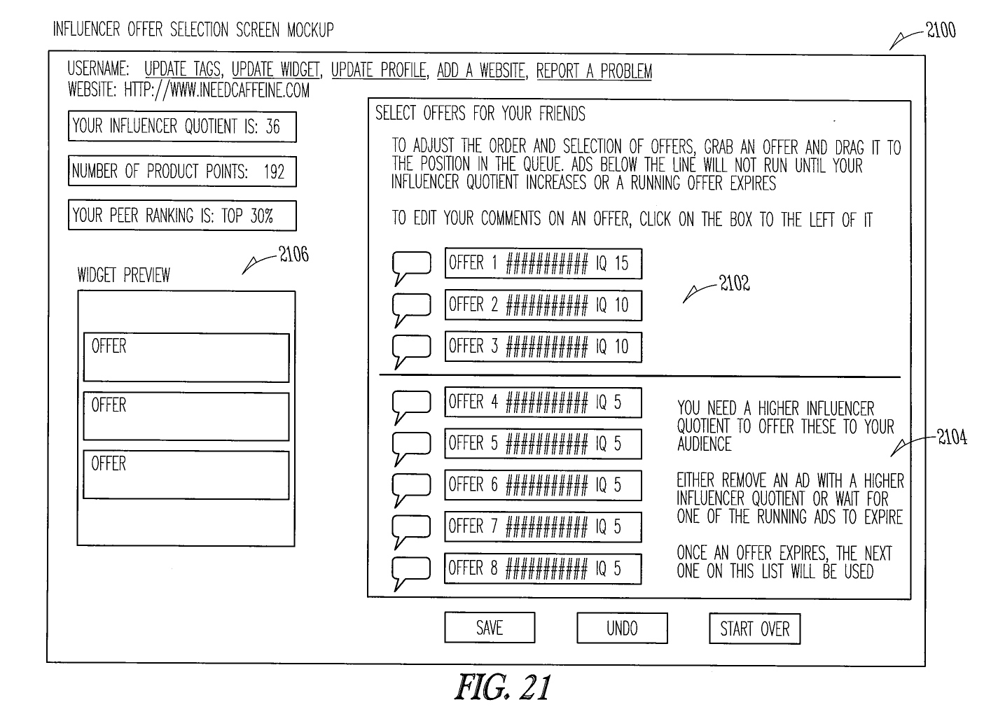

FIG. 21 illustrates a sample screen display 2100 for an Influencer offer selection screen in website 125. The screen shows the Influencer's Influencer Quotient, number of website points, and peer ranking. Offers 2102 may be selected. Also, some offers 2104 may not be available to be selected because the Influencer's Influencer Quotient is not high enough to gain access to the offers. In this way, for example, the Influencer is encouraged to obtain a higher Influencer Quotient. Widgets may be previewed in the left hand lower corner 2106.

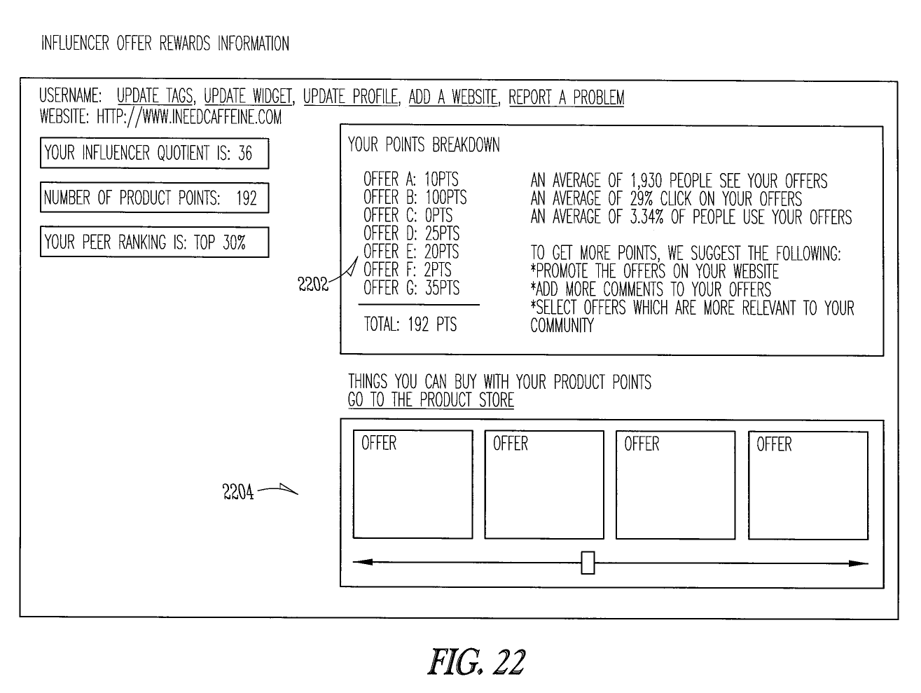

According to another example embodiment, the Influencer is offered rewards for selecting offers and successfully obtaining takers for those offers. FIG. 22 illustrates an example screen display showing the number of points earned for each offer 2202 and the total points. At the bottom of the screen is a viewing area 2204 to show gifts or rewards the Influencer can purchase with the earned reward points.

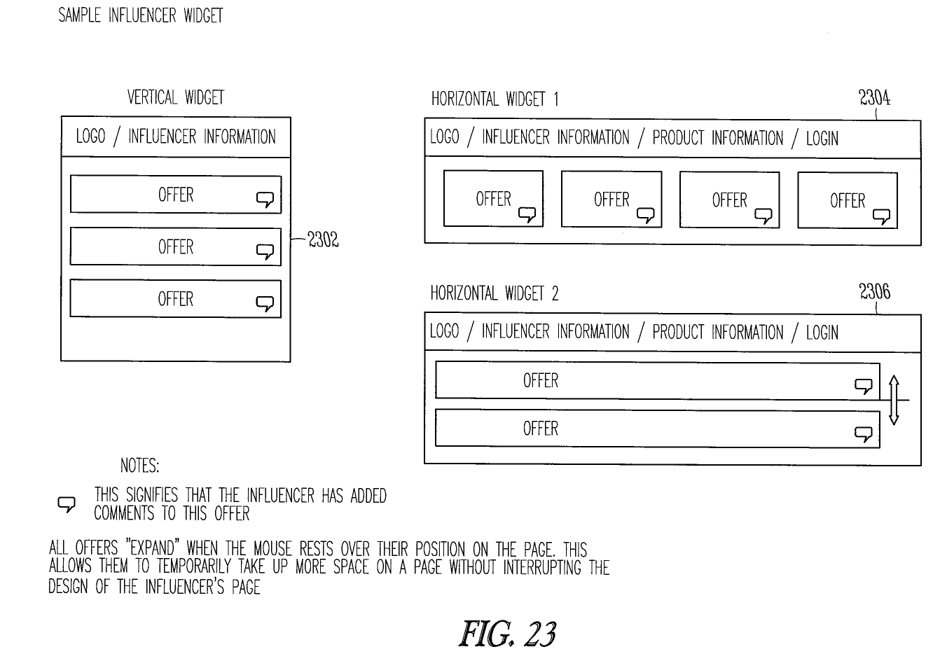

According to one example embodiment shown in FIG. 23, a variety of Widget configurations may be offered to Influencers, such as vertical Widgets 2302, or horizontal Widgets 2304 or 2306.

According to one example embodiment 2400 shown in FIG. 24, Influencers may be able to place comments, text or other messages 2402 in, on, or near the actual offers 2404 they have selected. Those comments, text or other messages 2402 may be displayed adjacent an offer 2404 when it is displayed using a widget on the Influencer's site. In one embodiment, to add comments, the user may click on an icon to the left of the selected offers 2404 and add comments in a process 2410 that results in the comments being stored on the server 120 and ultimately adjacent an offer in the display presented to an end-viewer using a widget.

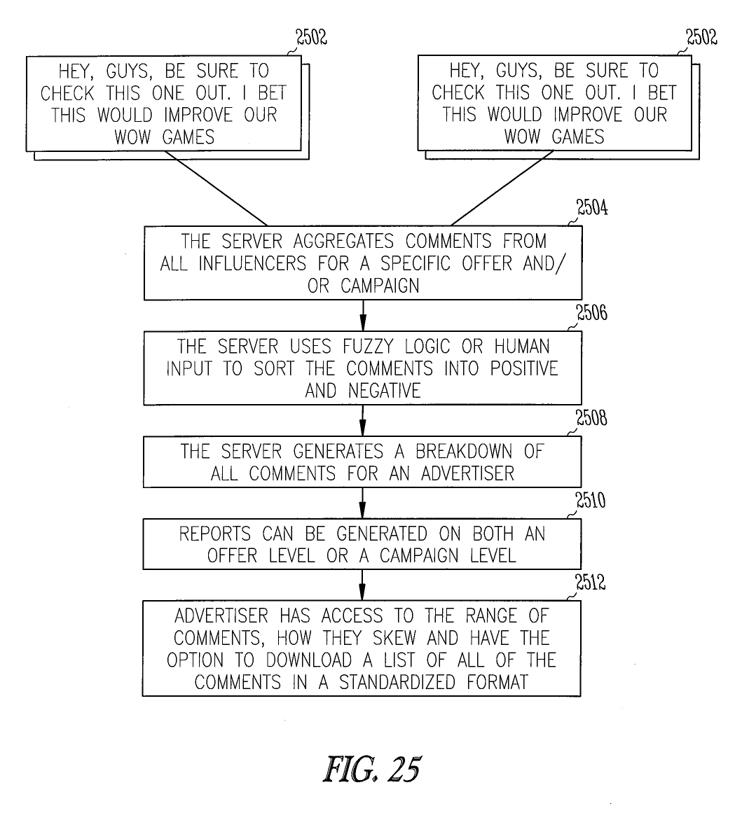

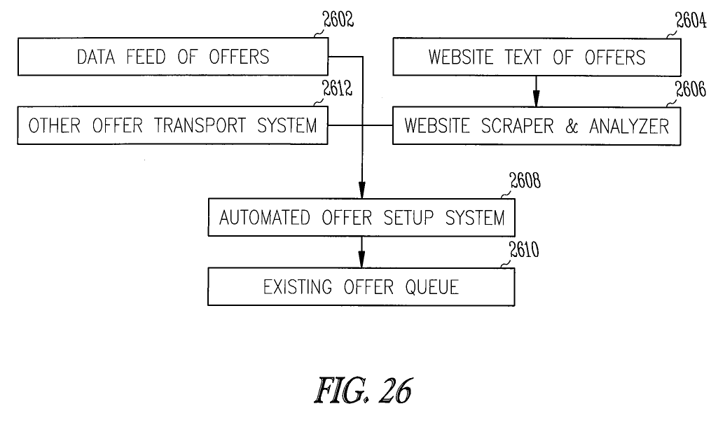

According to one example embodiment 2500 shown in FIG. 25, comments 2502 from all influencers may be aggregated 2504 and stored for analysis. These comments may be analyzed for general tone, positive/negative messages, length or other metrics. This can be done using human input or the server may use fuzzy logic 2506. These comments may be analyzed and the results provided 2508 to an Advertiser on a per-offer or per-campaign basis 2510. The full text of the comments may also be available to the Advertiser 2512.

According to one example embodiment of the inventive subject matter, Influencers and advertisers are matched using various approaches, including searches on demographics or other parameters other than or in combination with demographics. One approach as noted above is such that after an advertiser sets up a new campaign, the advertiser assigns the campaign “tags” which will best reach their audience. Website 125 may return the possible number of Influencers and audience size based on historical data, wherein fuzzy matches may be used, such as “nerd”=“geek”. Advertisers will then be able to see sample Influencers based on the keywords they enter. Psychographics and interests will be used, for example, to help identify Influencers based on the tags entered by the advertiser.

According to another example embodiment, there may be three sources for Tags used. A preliminary set of tags will be generated based on content of the page and who links to the site. For example, a link from Slashdot will assign tags such as “technology” “society” “nerd.” A crawler will crawl the site and break down the content into major tags and keywords useful in identifying the content of the page. User-defined self-tags may also be used. Presumably, a user can identify their site and their audience better than a crawler or other non-human mechanism. These tags may take precedence over automatically assigned tags. They may be editable any time for the Influencer. Third party sites may also be referenced, such as tags from Digg, Reddit, StumbleUpon, etc. These tags may be used to provide an objective evaluation of sites.

Offers, in one example embodiment, may have comments attached by Influencers. Influencers may be free to leave any sort of comment with the possibility intent that they leave endorsements for a specific offer.

Further, according to one example embodiment, instead of Influencers only, any web-based proprietor may be offered an opportunity to sign up and select offers to offer to their readership. Accordingly, in this embodiment, the web-based proprietor need not espouse any personal viewpoints or opinions or have any following or audience as an Influencer may, but instead may simply have customers that visit the web-based proprietor's website or pages to access factual information or conduct commerce or for any other purpose. The web-based proprietor may, like Influencers described above, nonetheless characterize their end viewers and be offered offers to present to their end viewers to the same extent possible as Influencers.

In the above example embodiment, these comments may be analyzed by the inventive subject matter and reported to Advertisers. These comments may be used to help refine message strategies or to better target receptive audiences.

According to another example embodiment 26, advertisers may not directly create offers for the subject matter. Content sources, such as established online retailers, may explicitly or unknowingly provide offers to the system described. The system may either explicitly take product information, through a data feed 2602 or the target site 2604 may be scraped and analyzed by the system 2606. Offers are generated using an automated or semi-automated process 2608 and added to the offer queue 2610 for Influencers to select. Alternatively, a non-web system may be arranged where a content provider provides offers to Influencers through some other mechanism, electronic or offline 2612.

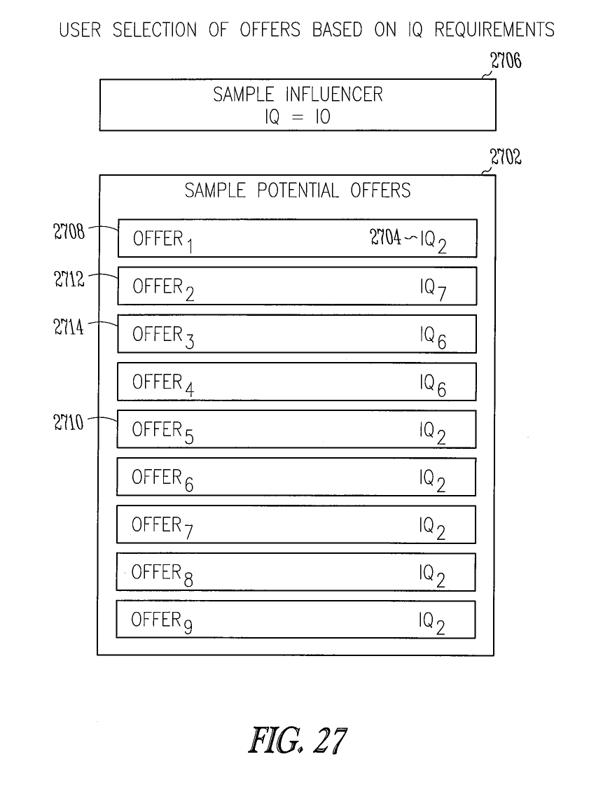

In one example embodiment, as illustrated in FIG. 27, users may choose between better offers or a larger quantity of offers 2702 based on their Influencer Quotient 2706. In an embodiment, each offer is assigned an IQ value 2704. Offer IQ's 2704 may be assigned based on product price, discount value, or other arbitrary measure. An influencer's IQ 2706 may allow them to select individual offers (e.g., 2708, 2710, 2712, and 2714) that sum up to their IQ or lower. For example, if an influencer chooses sample offer 2708 with an IQ value of two and sample offer 2710 with an IQ value of two, the sum would be lower than the influencer's quotient of ten and thus allowed. However, if the influencer selects sample offer 2712 with an IQ of seven and same offer 2714 with an IQ of six, the sum would be greater then the allowed influencer quotient. Once an offer expires or is removed from the widget, the points it occupied may be recycled and may be used to select other offers.

According to another example embodiment, the user interactions may not take place on a website owed or operated by the Influencer. 3rd party websites may be used, such as social networks, to facilitate the user interactions or to allow quick adoption of the subject matter. In this potential embodiment, Influencers may use tools from their existing platform to install the subject matter.

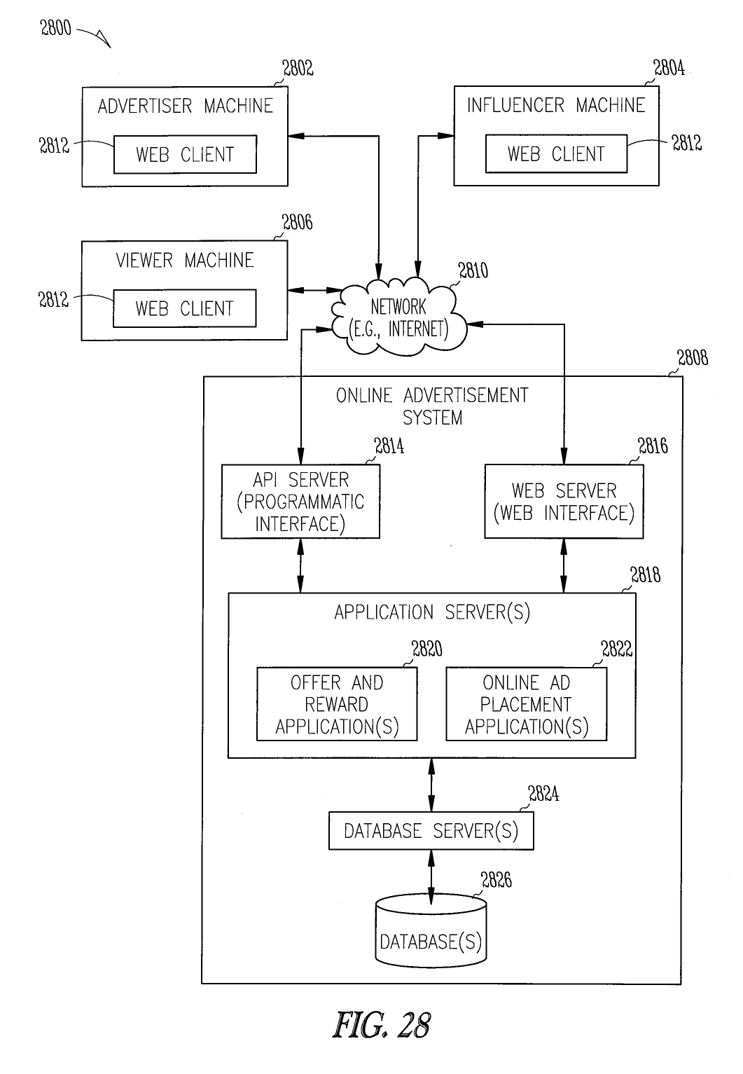

FIG. 28 is a network diagram depicting a system 2800, according to one example embodiment of the invention, using a client-server architecture. An online advertisement system 2808 (e.g., a network-based online advertisement system facilitating advertisements and offers between multiple influencers, viewers, and advertisers) provides server-side functionality via a network 2810 (e.g., the Internet) to one or more clients, such as a web client 2812 (e.g., a browser, such as the Internet Explorer browser developed by Microsoft Corporation of Redmond, Wash. or the FireFox browser provided by Mozilla Corporation of Mountain View, Calif., or a wireless browser, as is used in the case of certain cellular telephones). Communicatively coupled to the network 2810 is one or more of an advertiser machine 2802, an influencer machine 2804, and a viewer machine 2812. Each of the machines 2802, 2804, and 2806 may further include (or provide access to) communications applications (e.g., email, instant messaging, text chat, or Voice over IP (VoIP) applications), enabling users of the online advertisement system 2808 to communicate.

An Application Program Interface (API) server 2814 and a web server 2816 may be coupled, and provide program and web interfaces respectively, to one or more application servers 2818. The application servers 2818 may host one or more offer and reward applications 2820 and online ad placement applications 2822. The application servers 2818 may, in turn, be coupled to one or more databases servers 2824 that facilitate access to one or more databases 2826. The web client 2812 may access the offer and reward applications 2820 and online ad placement applications 2822 via the web interface supported by the web server 2816.

Further, while the system 2800 shown in FIG. 28 employs a client-server architecture, embodiments of the invention are not limited to such, and may just as well utilize a distributed, or peer-to-peer, architecture. The various offer and reward applications 2820 and online ad placement applications 2822 may also be implemented as standalone software programs, with or without individual networking capabilities.

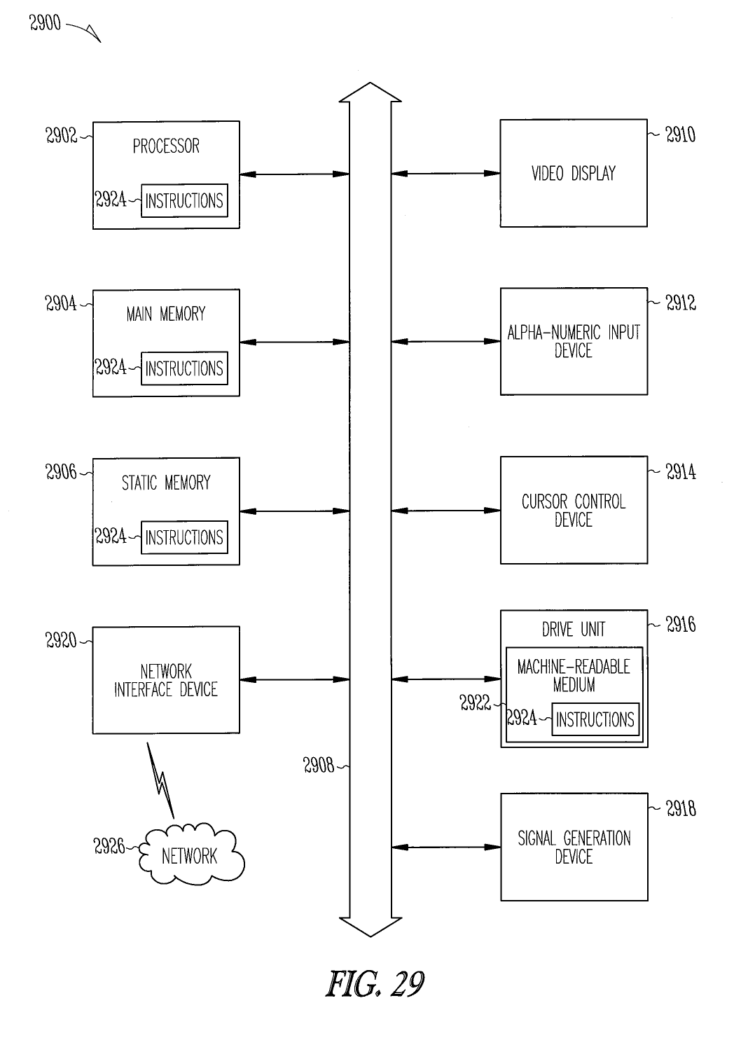

FIG. 29 shows a diagrammatic representation of a machine in the exemplary form of a computer system 2900 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 2900 includes a processor 2902 (e.g., a central processing unit (CPU) a graphics processing unit (GPU) or both), a main memory 2904 and a static memory 2906, which communicate with each other via a bus 2908. The computer system 2900 may further include a video display unit 2910 (e.g., a liquid crystal display (LCD) or a cathode ray tube (CRT)). The computer system 2900 also includes an alphanumeric input device 2912 (e.g., a keyboard), a cursor control device 2914 (e.g., a mouse), a disk drive unit 2916, a signal generation device 2918 (e.g., a speaker) and a network interface device 2920.

The disk drive unit 2916 includes a machine-readable medium 2922 on which is stored one or more sets of instructions (e.g., software 2924) embodying any one or more of the methodologies or functions described herein. The software 2924 may also reside, completely or at least partially, within the main memory 2904 and/or within the processor 2902 during execution thereof by the computer system 2900, the main memory 2904 and the processor 2902 also constituting machine-readable media. The software 2924 may further be transmitted or received over a network 2926 via the network interface device 2920.

While the machine-readable medium 2922 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Thus, as described herein, according to one example embodiment, the system described herein supports online marketing programs designed to leverage the power of peer-recommendations to promote actions desired by advertisers. The system thus may create a virtuous-circle, since Influencers that are able to offer their communities the most valuable advertiser-offers will likely see their reputations enhanced and their Viewer communities grow. Their IQ score will increase and as a result, they will receive the right to view and select even more valuable offers for their Viewers. Thus, using the system described herein, advertisers may follow the trail of blogs and social networking sites to find and recruit customers all over the world.

According to other alternative embodiments, any of the systems and methods described herein above, or as set forth in the accompanying claims, may further be embodied as a computer-readable product or article of manufacture wherein instructions may be tangibly embodied to perform the systems and methods described.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

1. A system comprising:
one or more web servers;
a first function supported by the one or more web servers allowing an influencer to establish and account and characterize the influencer's audience;
a second function allowing one or more advertisers to enter ads and determine which influencers would be suited to run the ads on the influencer's web site or page(s);
a third function allowing the advertiser to offer selected influencers the opportunity to advertise an advertising offer for the advertiser;
a fourth function allowing an influencer to select an offered advertising offer and run it on their web site or page(s) using one or more elements of computer code or data downloaded from the one or more web servers; and
a fifth function tracking at least one parameter for one or more of the influencers that is used to at least in part determine which of the advertising offers the influencer is allowed to select.

2. A system according to claim 1 further including a sixth function of collecting influencer comments and providing them in a report format to the sponsoring advertiser, a seventh function of rewarding influencers for desirable actions performed by their community, and an eighth function of managing the administration, billing, expiration, etc of offers placed by advertisers.

3. A system according to claim 1 further including a function for allocating rewards to one or more of the influencers to reward the influencer for successfully presenting offers or gaining customers for an advertiser through a presented offer.

4. A system according to claim 1 further including a seventh function for invoicing advertisers for the placement or success of offers placed by one or more of the influencers.

5. A system comprising:
one or more web servers;
a first function supported by the one or more web servers allowing a first party to establish an account and characterize the first party's audience;
a second function allowing one or more advertisers to enter ads and determine which of the first parties would be suited to run the ads on the first parties web site or page(s);
a third function allowing the advertiser to offer selected first parties the opportunity to advertise an advertising offer for the advertiser;
a fourth function allowing a first party to select an offered advertising offer and run it on their web site or page(s) using one or more elements of computer code or data downloaded from the one or more web servers; and
a fifth function tracking at least one parameter for one or more of the first parties that is used to at least in part determine which of the advertising offers the first party is allowed to select.

6. A system comprising:
one or more web servers and one or more client computers connected to a wide area network;
a software system executing on the one or more web servers and/or the one or more client computers to:
maintain influencer data characterizing the web audience of an influencer, wherein the influencer publishes content on at least one web page(s) or web site on the wide area network;
enable the advertiser to view at least some of the influencer data and offer one or more selected influencers the opportunity to display an advertising offer for the advertiser, wherein the viewing and offer are performed on one or more client computers served by the one or more web servers;
enable an influencer to select an offered advertising offer and display it on their web site or web page(s) using one or more elements of computer code and/or data downloaded from the one or more web servers, wherein the displayed advertising offer includes at least one hyperlink that may be selected by a visitor to the web site or web page(s); and
track at least one parameter for one or more of the influencers that is at least in part determined by the success of an influencer to get visitors to select the hyperlinks on displayed advertising offers, and further wherein the parameter is used at least in part determine which of the advertising offers the influencer is allowed to select.

7. A system according to claim 6 further wherein the software system enables an influencer to add at least one comment or indication to an advertising offer that is displayed.

8. A system according to claim 7 further wherein the software system enables collecting influencer comments and providing them in a report format to the advertiser.

9. A system according to claim 6 further wherein the software system enables the maintaining of a metric of the success of the one or more influencers in relation to the display of advertisements, and further enables one of the influencers to obtain rewards for their success based on the metric.

10. A system according to claim 6 further wherein the software system includes a function for allocating rewards to one or more of the influencers to reward the influencer for successfully presenting offers or gaining customers for an advertiser through a presented offer.

11. A system comprising:
one or more widgets installed on an influencer's web pages or web site;
a computer system including at least one web server enabling the influencer to use a client computer to search for advertising offers, select one or more of the advertising offers, and add or modify a comment on an advertising offer; and
wherein the selected advertising offer with or without a comment is displayed using the one or more widgets.

12. A system according to claim 11 further wherein the computer system includes a software system to track the impressions or selection of advertising offers by visitors to the influencer's web pages or web site and/or conversions related to selected advertising offers.

13. A system according to claim 11 further wherein the computer system includes a software system to track points or credits awarded to one of the influencers, wherein the points or credits may be redeemed by the influencer for products, services, cash or other value.

14. A system comprising:
one or more influencer web page(s) or web site;
a computer system including at least one web server enabling the influencer to use a client computer to search for advertising offers, select one or more of the advertising offers, and add or modify a comment on an advertising offer; and
wherein the selected advertising offer with or without a comment is displayed on the one or more web pages or web site.

15. A system according to claim 14 further wherein the computer system includes a software system to track the impressions and/or selection of advertising offers by visitors to the influencer's web pages or web site and/or conversions related to selected advertising offers.

16. A system according to claim 14 further wherein the computer system includes a software system to track points or credits awarded to one of the influencers, wherein the points or credits may be redeemed by the influencer for products, services, cash or other value.

17. A system comprising:
one or more influencer web page(s) or web site;
a computer system including at least one web server enabling the influencer to display advertising offers on the one or more influencer web page(s) or web site;
wherein the computer system includes at least one software function to track the impressions and/or selection of advertising offers by visitors to the influencer's web pages or web site and/or conversions related to selected advertising offers; and
the computer system further including at least one software function to track points or credits awarded to one of the influencers at least in part in relation to the success of the influencer in relation to the display of the advertising offers, wherein the points or credits may be redeemed by the influencer for products, services, cash or other value.

18. A system according to claim 17 wherein the computer system further includes at least one software function that enables an influencer to choose advertising offers to display on the one or more web page(s) or web site, wherein the advertising offers that are offered to the influencer to be selected and displayed are based at least in part on the success of the influencer in displaying advertising offers previously selected and displayed by the influencer.

19. A system comprising:
one or more influencer web page(s) or web site;
a computer system including at least one web server enabling the influencer to display advertising offers on the one or more influencer web page(s) or web site;
wherein the computer system includes at least one software function to track the impressions and/or selection of advertising offers by visitors to the influencer's web pages or web site and/or conversions related to selected advertising offers; and
wherein the computer system further includes at least one software function that enables an influencer to choose advertising offers to display on the one or more web page(s) or web site, wherein the advertising offers that are offered to an influencer to be selected and displayed are based at least in part on the success of the influencer in displaying advertising offers previously selected and displayed by the influencer.

20. A system according to claim 19 wherein the advertising offers offered to the influencer is based further at least in part on the size of the influencer's audience.

21. A system according to claim 20 wherein the audience size is determined at least in part based on the number of visitors to the influencer's one or more web page(s) or web site.

22. A system according to claim 20 wherein the computer system includes at least one software function to allow and advertiser to select one or more tags used to match to a target market, and wherein the influencer's are selected to receive offers of advertising offers based on the target market.

23. A computerized method comprising:
maintaining influencer data characterizing the web audience of an influencer, wherein the influencer publishes content on at least one web page(s) or web site on a wide area network;
enabling the advertiser to view at least some of the influencer data and offer one or more selected influencers the opportunity to display an advertising offer for the advertiser, wherein the viewing and offer are performed on one or more computers;
enabling an influencer to select an offered advertising offer and display it on their web site or web page(s) using one or more elements of computer code and/or data downloaded from at least one computer, wherein the displayed advertising offer includes at least one hyperlink that may be selected by a visitor to the web site or web page(s); and
track at least one parameter for one or more of the influencers that is at least in part determined by the success of an influencer to get visitors to select the hyperlinks on displayed advertising offers, and further wherein the parameter is used at least in part determine which of the advertising offers the influencer is allowed to select.

24. A method according to claim 23 further wherein the influencer adds at least one comment or indication to an advertising offer that is displayed.

25. A method according to claim 24 further including collecting influencer comments and providing them in a report format to the advertiser.

26. A method according to claim 23 further wherein including maintaining a metric of the success of the one or more influencers in relation to the display of advertisements, and wherein at least one of the influencers obtains rewards for their success based on the metric.

27. A method according to claim 23 further wherein rewards are allocated to one or more of the influencers to reward the influencer for successfully presenting offers or gaining customers for an advertiser through a presented offer.

28. A method comprising:
installing one or more widgets on an influencer's web pages or web site;
the influencer using a computer to search for advertising offers, select one or more of the advertising offers, and add or modify a comment on an advertising offer; and
wherein the selected advertising offer with or without a comment is displayed using the one or more widgets.

29. A method according to claim 28 further including tracking the impressions or selection of advertising offers by visitors to the influencer's web pages or web site and/or conversions related to selected advertising offers.

30. A method according to claim 28 including tracking points or credits awarded to one of the influencers, wherein the points or credits may be redeemed by the influencer for products, services, cash or other value.

31. A method comprising:
an influencer using a computer to search for web-based advertising offers, select one or more of the advertising offers, and add or modify a comment on an advertising offer; and
wherein the selected advertising offer with or without a comment is displayed on the one or more web pages or web site.

32. A method according to claim 31 further including tracking the impressions and/or selection of advertising offers by visitors to the influencer's web pages or web site and/or conversions related to selected advertising offers.

33. A method according to claim 31 further including tracking points or credits awarded to one of the influencers, wherein the points or credits may be redeemed by the influencer for products, services, cash or other value.

34. A method comprising:
an influencer to display advertising offers on one or more influencer web page(s) or web site;
tracking the impressions and/or selection of advertising offers by visitors to the influencer's web pages or web site and/or conversions related to selected advertising offers; and
tracking points or credits awarded to one of the influencers at least in part in relation to the success of the influencer in relation to the display of the advertising offers, wherein the points or credits may be redeemed by the influencer for products, services, cash or other value.

35. A method according to claim 34 including enabling the influencer to choose advertising offers to display on the one or more web page(s) or web site, wherein the advertising offers that are offered to the influencer to be selected and displayed are based at least in part on the success of the influencer in displaying advertising offers previously selected and displayed by the influencer.

36. A method comprising:
an influencer displaying advertising offers on one or more influencer web page(s) or web site;
tracking the impressions and/or selection of advertising offers by visitors to the influencer's web pages or web site and/or conversions related to selected advertising offers; and
enabling an influencer to choose advertising offers to display on the one or more web page(s) or web site, wherein the advertising offers that are offered to an influencer to be selected and displayed are based at least in part on the success of the influencer in displaying advertising offers previously selected and displayed by the influencer.

37. A method according to claim 36 wherein the advertising offers offered to the influencer is based further at least in part on the size of the influencer's audience.

38. A method according to claim 37 wherein the audience size is determined at least in part based on the number of visitors to the influencer's one or more web page(s) or web site.

39. A method according to claim 37 wherein the advertiser can select one or more tags used to match to a target market, and wherein the influencer's are selected to receive offers of advertising offers based on the target market.
